(19) United States
(12) Patent Application Publication
(10) Pub. No.: US 2012/0019412 A1
(43) Pub. Date: Jan. 26, 2012

(54) GPS TERMINAL, POSITIONING METHOD, COMMUNICATION SYSTEM, AND PROGRAM

(75) Inventors: Yoshihisa Manzen, Tokyo (JP); Makoto Takahashi, Tokyo (JP); Syun Tsuyuki, Tokyo (JP)

(73) Assignees: NTT DOCOMO, INC, Chiyoda-ku, Tokyo (JP); NEC CORPORATION, Tokyo (JP)

(21) Appl. No.: 13/262,140

(22) PCT Filed: Mar. 26, 2010
(86) PCT No.: PCT/JP2010/055320

§ 371 Date: Sep. 29, 2011

(30) Foreign Application Priority Data
Mar. 30, 2009 (JP) 2009-082913

(51) Int. Cl. G01S 19/25

(52) U.S. Cl. 342/357.64

(57) ABSTRACT

A GPS terminal, comprises: a communication unit that receives assist data from a network, the assist data used for positioning via GPS (Global Positioning System); and a GPS positioning unit that receives a GPS signal using the assist data and outputs a positioning result. A communication session with the network is released without waiting for said GPS positioning unit to complete positioning.

### CROSS-REFERENCE TO RELATED APPLICATIONS

The present invention claims priority from Japanese Patent Application 2009-082913 (filed on Mar. 30, 2009) the content of which is hereby incorporated in its entirety by reference into this specification.

### TECHNICAL FIELD

The present invention relates to a GPS (Global Positioning System) terminal, a positioning method, a communication system, and a program, and more particularly to a GPS terminal, a positioning method, a communication system, and a program that perform positioning using assist data received from a network.

### BACKGROUND ART

Recently, the A-GPS method (Assisted GPS, also called a network assisted GPS), which utilizes the communication function of a mobile phone terminal to receive assist data from a network for implementing highly-sensitive, high-speed positioning, has become a mainstream as the GPS method for a mobile phone terminal. More specifically, the A-GPS method acquires information, such as an approximate time, an approximate position, and GPS satellite navigation data, from a network as assist data to implement positioning that has higher speed and accuracy than point positioning GPS.

FIG. 4 is a sequence diagram showing the operation of a mobile terminal that performs positioning in the A-GPS method. As shown in FIG. 4, when a positioning start event is generated (step S1), the mobile terminal first establishes a communication session with the network (step S2). Next, the mobile terminal requests the network to transmit assist data acquires it (steps S3 and S4) and, using the assist data, performs GPS positioning (step S5). When the GPS positioning is terminated (step S6), the mobile terminal notifies the positioning result to the network side (step S7) and releases the communication session (step S8). For brevity of description, detailed message exchanges are omitted in the example in FIG. 4. The positioning result notified to the network is used, for example, for services for providing current location information on a mobile device.

Patent Document 1 discloses a network assisted GPS terminal that reduces the number of times the communication is carried out for obtaining approximate location information included in the assist data. According to the document, if the cell information received from the communication unit in the second or the following GPS positioning is the same as that obtained by the immediately preceding GPS positioning, the approximate location, obtained in the immediately preceding GPS positioning, is supplied to the GPS unit to reduce the number of times the approximate location is obtained from the network.

Patent Document 2 discloses a GPS positioning system that provides, in the network side, means for calculating and providing not only the approximate locations but the altitude information based on the actual geographical features and, based on the altitude information received from the network side, switches positioning between three-dimensional positioning and two-dimensional positioning.

### PRIOR ART DOCUMENT

### Patent Document

### Patent Document 1:

Japanese Patent Kokai Publication No. JP2005-83859A

### Patent Document 2:

Japanese Patent Kokai Publication No. JP2005-147720A

### DISCLOSURE OF THE INVENTION

### Problems to be Solved by the Invention

The disclosure of Patent Documents quoted above is incorporated herein by reference thereto.

Services have been expanded that utilize user's location information determined by GPS. Meanwhile, it becomes increasingly important to minimize the current consumption during GPS positioning to prolong the battery life.

For example, the method disclosed in Patent Document 1 reduces the number of times the approximate location is acquired from the network. However, from the time a communication session is established to the time the communication session is released (steps S2-S8) in FIG. 4 shown above, the need to maintain the communication state (connection state) with the network requires current consumption. For example, when a mobile terminal is moving at a high speed, the method in Patent Document 1 acquires the approximate location as before and therefore requires a large amount of power consumption.

The inventor of the present invention has found the fact that the positioning result, notified to the network side in step S7 in FIG. 4, is not necessarily used in all services and applications.

In view of the foregoing, it is an object of the present invention to provide a GPS terminal, a positioning method, a communication system, and a program for reducing current consumption at GPS positioning time to prolong the battery life.

### Means to Solve the Problems

According to a first aspect of the present invention, there is provided a GPS terminal comprising a communication unit that receives assist data from a network, the assist data used for positioning via GPS (Global Positioning System); and a GPS positioning unit that receives a GPS signal using the assist data and outputs a positioning result wherein a communication session with the network is released without waiting for the GPS positioning unit to complete positioning.

According to a second aspect of the present invention, there is provided a positioning method comprising the steps of receiving assist data from a network, the assist data used for positioning via GPS (Global Positioning System); after receiving assist data from the network side, returning a positioning result, created without using the assist data, as a response; and receiving a GPS signal using the assist data and outputting a positioning result.

According to a third aspect of the present invention, there is provided a communication system including the GPS terminal described above and an assist server that transmits assist data to the GPS terminal.

According to a fourth aspect of the present invention, there is provided a program causing a computer, installed in a GPS terminal, to perform processing of receiving assist data from a network, the assist data used for positioning via GPS (Global Positioning System); after receiving assist data from the network side, processing of returning a positioning result, created without using the assist data, as a response; and processing of receiving a GPS signal using the assist data and outputting a positioning result.

### Effect of the Invention

The present invention can reduce the current consumption when a GPS terminal performs positioning and therefore prolong the battery life. The reason is that the GPS terminal is configured to release the communication session with the network without waiting for the completion of positioning by the GPS positioning unit so that the communication time (connection time) with the network is reduced.

### BRIEF DESCRIPTION OF THE DRAWINGS

FIG. 1 is a sequence diagram showing the operation of a GPS terminal in a first exemplary embodiment of the present invention.

FIG. 2 is a block diagram showing the configuration of the GPS terminal in the first exemplary embodiment of the present invention.

FIG. 3 is a sequence diagram showing the operation of a GPS terminal in a second exemplary embodiment of the present invention.

FIG. 4 is a diagram showing the outline of positioning in the A-GPS method.

### PREFERRED MODES FOR CARRYING OUT THE INVENTION

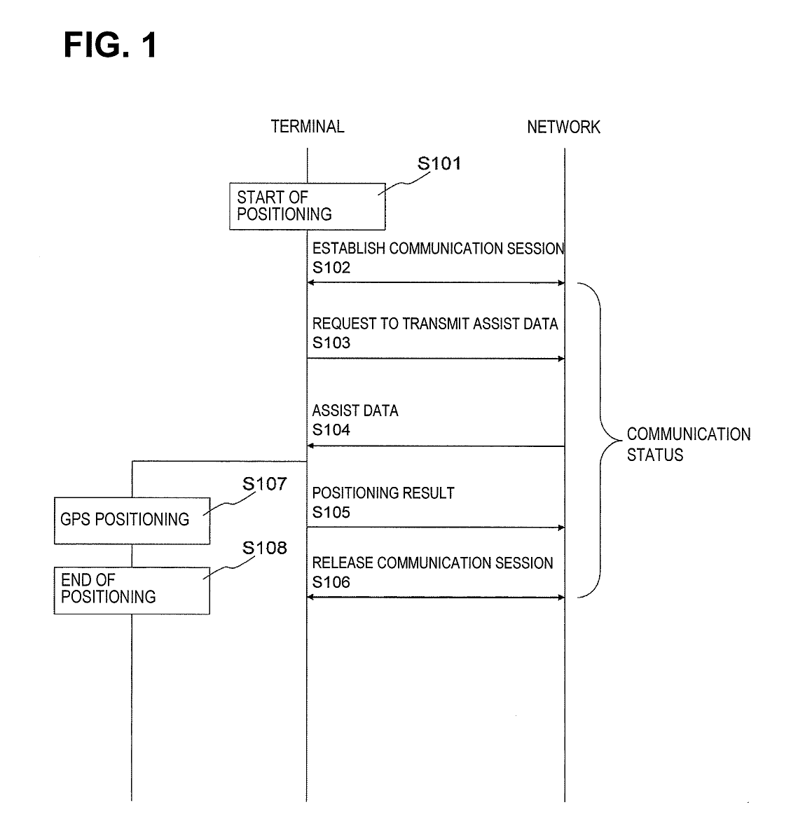

First, the following describes the outline of the present invention. After assist data is acquired from a network (see step S104 in FIG. 1), a GPS terminal according to the present invention notifies the positioning result to the network side and releases the communication session without waiting for the termination of GPS positioning (see step S105 and step S106 in FIG. 1). This method reduces the communication time with the network and reduces the current consumption.

After the communication session is released, GPS positioning is performed as described above. The present invention performs GPS positioning using assist data similarly as in the conventional method and therefore produces the result with no effect on positioning accuracy.

### First Exemplary Embodiment

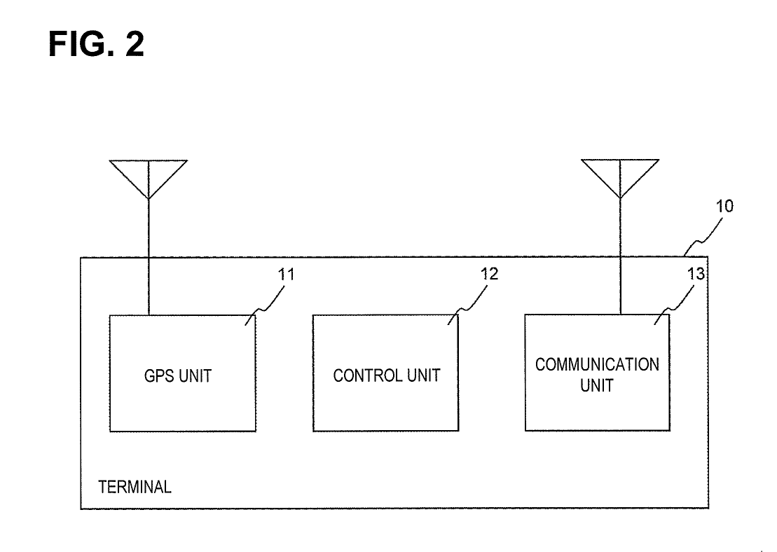

Next, the following describes preferred exemplary embodiments of the present invention more in detail with reference to the drawings. FIG. 2 is a block diagram showing the configuration of a GPS terminal in a first exemplary embodiment of the present invention. Referring to FIG. 2, the (GPS) terminal 10 comprises a GPS unit 11, a control unit 12, and a communication unit 13.

The GPS unit 11 uses assist data, acquired by the communication unit 13, to receive the GPS signal received from a GPS satellite. The GPS unit 11 comprises a module(s) such as a GPS module for outputting the positioning result.

The control unit 12 comprises a CPU (Central Processing Unit) that controls the components of the (GPS) terminal 10 such as the GPS unit 11 and the communication unit 13. More specifically, the control unit 12 supplies assist data, received from the network via the communication unit 13, to the GPS unit 11 to cause the GPS unit 11 to perform positioning and, in addition, controls the communication unit 13 to request the network side to transmit assist data and to notify the positioning result (release the session). The processing performed by the control unit 12 is implemented by a program(s) executed by the CPU that configures the control unit.

The communication unit 13, which is configured by a transmission/reception unit that modulates/demodulates data received via the antenna and a communication control unit that controls communication, carries out radio communication with the network and acquires assist data. More specifically, the communication unit 13 carries out radio communication with the nearest radio base station to register the position in the network and acquires assist data from an assist server installed on the network side.

Next, the following describes the operation of this exemplary embodiment more in detail with reference to the drawings. FIG. 1 is a sequence diagram showing the operation of the GPS terminal in the first exemplary embodiment of the present invention. Referring to FIG. 1, when a positioning start event is generated, for example, when a particular service-usage start operation is performed (step S101), the (GPS) terminal 10 establishes a communication session with the network (step S102) and then requests the network to transmit assist data (step S103).

When assist data is acquired from the network side (step S104), the (GPS) terminal 10 immediately notifies the positioning result to the network side (step S105) and releases the communication session (step S106).

The positioning result notified to the network side in step S105 described above may be a dummy positioning result or the initial position included in the assist data acquired previously from the network. That is, the positioning result may be created without using the positioning result generated by performing GPS positioning using the assist data acquired in step S104; in other words, the positioning result may be any data that acts as the notification means for releasing the communication session normally.

As a result, though the accurate GPS positioning result created using the assist data is not notified to the network side, there is no problem with services or applications that basically do not have to notify the positioning result to the network side. If the GPS positioning result, created using the assist data, is obtained in the GPS positioning that has already been performed, the most recent GPS positioning result may be transmitted.

In parallel with the above-described notification of the positioning result to the network side, the (GPS) terminal 10 performs GPS positioning using the assist data (step S107) and terminates the GPS positioning (step S108).

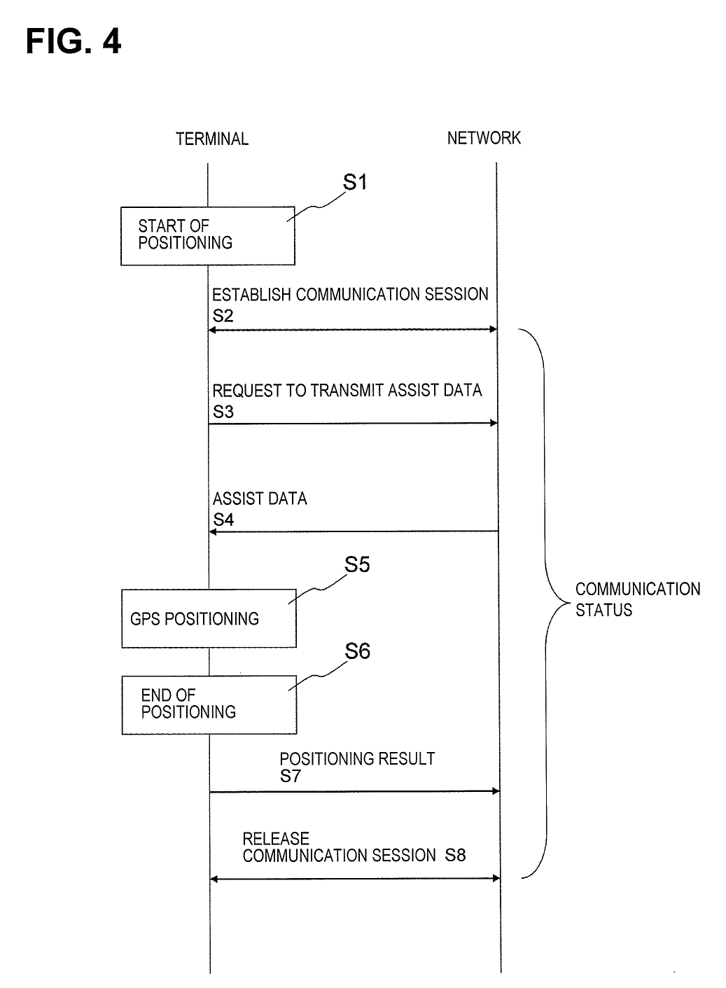

As described above, a session (i.e., a communication status with network) is released (terminated) in this exemplary embodiment as soon as possible after assist data is acquired without waiting for the completion of GPS positioning. As compared with the method shown in FIG. 4 in which a session is released after GPS positioning is completed, the method in this exemplary embodiment reduces the communication time (connection time) with the network side and reduces the current consumption at GPS positioning time. In addition, as compared with the method shown in FIG. 4, the method in this exemplary embodiment, which starts GPS positioning immediately after assist data is acquired, prevents the time required for GPS positioning from being increased.

### Second Exemplary Embodiment

Next, the following describes a second exemplary embodiment of the present invention created by adding changes to the first exemplary embodiment of the present invention described above. Because the second exemplary embodiment may be implemented by a (GPS) terminal having a configuration similar to that of the (GPS) terminal in the first exemplary embodiment described above, the following describes the operational difference between the two exemplary embodiments.

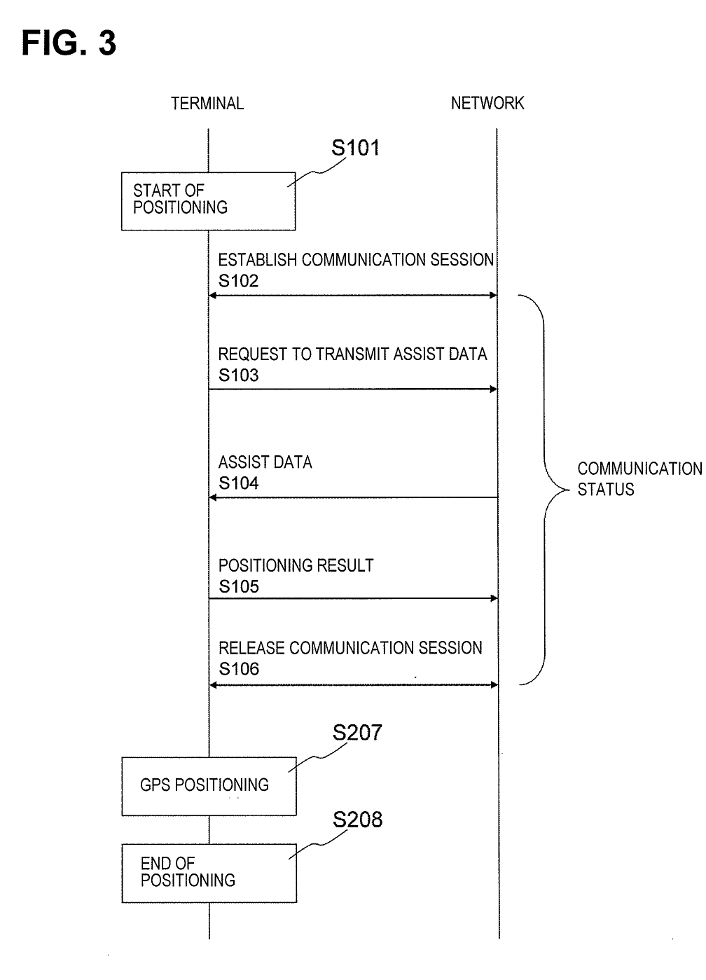

FIG. 3 is a sequence diagram showing the operation of a GPS terminal in the second exemplary embodiment of the present invention. The operation from the start of positioning (step S101) to the release of the communication section (step S106) in FIG. 3 is the same as that in the first exemplary embodiment described above and, therefore, the same numeral is used for the same operation step and its description is omitted.

When the release of the communication session is completed (step S106), the (GPS) terminal 10 performs GPS positioning using the assist data (step S207) and then terminates the GPS positioning (step S208).

As described above, positioning result notification (release of session) and GPS positioning are not performed in parallel after acquiring the assist data; instead, GPS positioning is performed after the positioning result is notified and the session is released. This method also reduces the communication time (connection time) with the network side and reduces the current consumption at GPS positioning time.

While the exemplary embodiments of the present invention have been described, it is to be understood that the present invention is not limited to the exemplary embodiments above and that changes, replacements, and adjustments may be added without departing from the basic technological concept of the present invention. For example, though the description is omitted in the above exemplary embodiments, a method such as the one described in Patent Document 1 is also possible in which assist data is held and, when there is no change in the approximate position, the request to transmit assist data is not issued. The exemplary embodiments of the present invention, if combined with such a method, further reduce the current consumption.

### INDUSTRIAL APPLICABILITY

The present invention is applicable not only to a mobile phone terminal with the GPS function but to a PDA (Personal Digital Assistant) with the communication function and the GPS function and to a vehicle-mounted GPS terminal with the function to coordinate with a mobile phone terminal.

### EXPLANATIONS OF SYMBOLS

10 Terminal (GPS terminal)
11 GPS unit
12 Control unit
13 Communication unit

1. A GPS terminal, comprising:
a communication unit that receives assist data from a network, the assist data used for positioning via GPS (Global Positioning System); and
a GPS positioning unit that receives a GPS signal using the assist data and outputs a positioning result, wherein
a communication session with the network is released without waiting for said GPS positioning unit to complete positioning.

2. The GPS terminal as defined by claim 1, wherein
after assist data is received from the network side, a positioning result, created without using the assist data, is returned as a response.

3. The GPS terminal as defined by claim 1, wherein
the positioning by said GPS positioning unit is started after a release of the communication session is completed.

4. The GPS terminal as defined by claim 1, wherein
the return of the response of the positioning result created without using the assist data and the positioning by said GPS positioning unit are performed in parallel.

5. A positioning method comprising:
receiving assist data from a network, the assist data used for positioning via Global Positioning System GPS;
after receiving assist data from the network side, returning a positioning result, created without using the assist data, as a response; and
receiving a GPS signal using the assist data and outputting a positioning result.

6. The positioning method as defined by claim 5, further comprising:
after a release of the communication session is completed, starting positioning by a GPS positioning unit.

7. The positioning method as defined by claim 5, wherein
the returning of the response of the positioning result created without using the assist data and positioning by a GPS positioning unit are performed in parallel.

8. A communication system, comprising the GPS terminal as defined by claim 1 and an assist server that transmits assist data to said GPS terminal.

9. A computer-readable recording medium recorded thereon a program causing a computer, installed in a GPS terminal, to perform:
processing of receiving assist data from a network, the assist data used for positioning via Global Positioning System GPS;
after receiving assist data from the network side, processing of returning a positioning result, created without using the assist data, as a response; and
processing of receiving a GPS signal using the assist data and outputting a positioning result.

10. The GPS terminal as defined by claim 2, wherein, as a positioning result created without using the assist data, one of a dummy positioning result, initial position data included in assist data acquired from the network before, and a result of positioning already performed is used.
